(19) United States
(12) Patent Application Publication
(10) Pub. No.: US 2018/0288818 A1
(43) Pub. Date: Oct. 4, 2018

(54) METHOD FOR CONNECTING A HOUSEHOLD APPLIANCE TO A WIRELESS HOME NETWORK

(71) Applicant: Vorwerk & Co. Interholding GmbH, Wuppertal (DE)

(72) Inventor: Lorenz HILLEN, Wuppertal (DE)

(73) Assignee: Vorwerk & Co. Interholding GmbH, Wuppertal (DE)

(21) Appl. No.: 15/943,878

(22) Filed: Apr. 3, 2018

(30) Foreign Application Priority Data
Apr. 3, 2017 (DE) 10 2017 107 088.5

(51) Int. Cl. H04W 76/11; H04L 12/28; G06K 7/10

(52) U.S. Cl. CPC H04W 76/11; H04L 12/2859; H04L 12/2807; G06K 7/1095; H04L 12/2876

(57) ABSTRACT

The invention pertains to a method for connecting a household appliance (1) to a wireless home network (2), wherein the household appliance (1) makes available a temporary network (3) with a hotspot identification (4), wherein a user terminal (5) is connected to the household appliance (1) via the temporary network (3) by utilizing the hotspot identification (4), wherein the user terminal (5) transmits network access information (16) to the household appliance (1), and wherein the household appliance (1) closes the temporary network (3) after the reception of the network access information (16) and logs on to the home network (2) by utilizing the received network access information (16). In order to enhance methods known from the prior art, it is proposed that the hotspot identification (4) of the temporary network (3) is randomly generated by means of a random character generator (6).

### TECHNICAL FIELD

The invention pertains to a method for connecting a household appliance to a wireless home network, wherein the household appliance makes available a temporary network with a hotspot identification, wherein a user terminal is connected to the household appliance via the temporary network by utilizing the hotspot identification, wherein the user terminal transmits network access information to the household appliance, and wherein the household appliance closes the temporary network after the reception of the network access information and logs on to the home network by utilizing the received network access information.

The invention furthermore pertains to a household appliance with a hotspot device for making available a temporary network and with a device for making available a hotspot identification for accessing the temporary network.

### PRIOR ART

Methods and household appliances of the above-described type are known from the prior art.

For example, patent EP 1 309 127 B1 discloses a method for connecting a device to an existing wireless network, to which multiple communication devices are connected. The communication devices have the same identification for the communication. The device to be newly connected to the network features a memory, in which a communication identification for a temporary wireless network is stored in advance. Based on this communication identification, the device establishes a temporary wireless network, to which a communication device that is already logged on to the existing wireless network can connect in order to transmit network access information for the existing wireless network to the device to be newly connected. The device to be connected stories the network access information, closes the temporary wireless network and connects to the existing wireless network by utilizing the received network access information.

### SUMMARY OF THE INVENTION

Based on the above-described prior art, the invention aims to develop an alternative method for connecting a household appliance to a wireless home network, in which the hotspot identification does not have to be stored within the household appliance in advance.

In order to attain the aforementioned objective, the invention proposes that the hotspot identification of the temporary network is randomly generated by means of a random character generator.

In contrast to the prior art, the hotspot identification for the temporary network is no longer stored in a memory of the household appliance or on a label on a housing of the household appliance, but rather effectively and individually generated on demand. Consequently, a different hotspot identification for connecting a user terminal to the temporary network of the household appliance is generated each time a temporary network is established. This makes it possible to assign the hotspot identification used to a certain output time on the one hand and to restrict the access authorization to the temporary network on the other hand. Furthermore, the hotspot identification is only available while or shortly before the temporary network is established and not located on the household appliance itself, where it is visible to everybody, or in a technical manual of the household appliance as it is common practice in the prior art. Last but not least, this also protects against unauthorized access to the temporary network of the household appliance. The random character generator generates a sequence of random characters from a certain character range. One can basically distinguish between two different types of random character generators, namely deterministic random character generators and non-deterministic random character generators. A non-deterministic random character generator generates different random characters under identical starting conditions. For this purpose, the generation of the random characters is made dependent, e.g., on an external non-deterministic parameter such as, for example, on pulse fluctuations of an electronic circuit of the household appliance or the like. A deterministic random character generator, in contrast, always delivers the same sequence of characters, which are selected from a defined quantity, under identical starting conditions. Both types of random character generators may be used in the inventive method.

It is proposed that the random character generator generates the hotspot identification immediately before the temporary network is established or at the moment the temporary network is established. Consequently, the hotspot identification is exactly generated at the moment, at which the temporary network should be established or is established. As soon as the household appliance makes available a temporary network, the hotspot identification required by a user terminal for transmitting the network access information to the household appliance is also available. It is therefore not necessary to store the hotspot identification in advance. In fact, the hotspot identification does not exist until the moment, at which it is actually required. The same hotspot identification can be transmitted multiple times while the temporary network is established. Alternatively, it is also possible to respectively generate a new hotspot identification within certain time intervals. In the latter instance, in particular, it is also not necessary to store the hotspot identification after the temporary network has been established.

It is particularly proposed that the hotspot identification is generated in the form of a sequence of randomly selected numerals and/or letters and/or special characters. The hotspot identification therefore comprises a plurality of characters that may consist of numerals, letters and/or special characters. In this context, it is particularly advantageous to select a combination of numerals and letters. The number of characters of the hotspot identification is basically unlimited. Consequently, the number of characters contained in the hotspot identification may lie between at least one character and a sequence of ten, twenty or even more characters. In this context, the security of the hotspot identification increases with the number of characters.

According to an embodiment, it is proposed that the hotspot identification is output in the form of an optical code. The hotspot identification particularly may be displayed on a screen of the household appliance in the form of a two-dimensional code. It is particularly preferred that the two-dimensional code is a QR® code (Quick Response code). The optical code advantageously comprises a pattern, for example a black-and-white pattern, which contains the hotspot identification in encoded form. Such an optical code may consist, for example, of a barcode, a QR code or another pattern-like code. In order to generate the optical code, the household appliance features a computing unit, for example a QR code generator, which can transform a hotspot identification consisting of multiple characters into an optical code.

It is proposed that the optical code is received by means of an image sensor of the user terminal. For example, the image sensor of the user terminal may be a camera or at least a camera chip. If the user terminal consists, for example, of a mobile telephone, a tablet computer or a laptop of the user, this user terminal usually features an image sensor anyway.

In this context, it is particularly proposed that the optical code is processed by means of an application installed on the user terminal and the hotspot identification is extracted from the optical code. The optical code received by the image sensor of the user terminal is additionally processed by means of the application installed in the user terminal in such a way that the hotspot identification is made available in a form, which enables the user terminal to connect to the temporary network of the household appliance.

It is furthermore proposed that the hotspot identification becomes invalid no later than at the time, at which the temporary network is closed. According to this embodiment, the usability of the hotspot identification generated by the random character generator is limited in time. For example, the validity of the hotspot identification may be limited to a few minutes after its output. A hotspot identification transmitted to the household appliance after the end of its validity is ignored such that it is no longer possible to respectively access the temporary network or transmit network access information to the household appliance, namely even if a new temporary network is established.

In addition to the above-described method for connecting a household appliance to a wireless home network, the invention furthermore proposes a household appliance with a hotspot device for making available a temporary network and with a device for making available a hotspot identification for accessing the temporary network, wherein the device for making available the hotspot identification features a random character generator, which is designed for generating the hotspot identification of randomly selected numerals and/or letters and/or special characters. The inventive household appliance is therefore designed for carrying out a method of the above-described type for supplying network access information to a household appliance, which does not feature its own user interface for manually inputting network access information. The hotspot device for making available a temporary network is preferably a network module, for example a WLAN module, which can take on the function of an access point. According to the invention, the device for making available the hotspot identification features a random character generator that randomly generates the hotspot identification. The associated advantages and characteristics can be gathered from the preceding description of the inventive method.

It is furthermore proposed that the household appliance features a screen for displaying a two-dimensional optical code containing the hotspot identification. The two-dimensional optical code particularly may be a QR code.

The household appliance may be a floor treatment apparatus, for example a cleaning apparatus. The household appliance may either be realized in the form of a user-operated household appliance or in the form of a self-traveling household appliance, particularly a robot. Furthermore, the invention can also be used in conjunction with other household appliances, for example polishers, grinders, cleaning apparatuses for floor coverings, mowers, kitchen appliances, miscellaneous service units, entertainment devices or the like.

### BRIEF DESCRIPTION OF THE DRAWINGS

The invention is described in greater detail below with reference to exemplary embodiments. In the drawings:

FIG. 1 shows a household appliance and a home network with an access point and a user terminal,

FIG. 2 shows the transmission of hotspot identification and network access information via a temporary network of the household appliance,

FIG. 3 shows the process of connecting the household appliance to the home network, and

FIG. 4 shows the home network with the household appliance, the access point and the user terminal.

### DESCRIPTION OF THE EMBODIMENTS

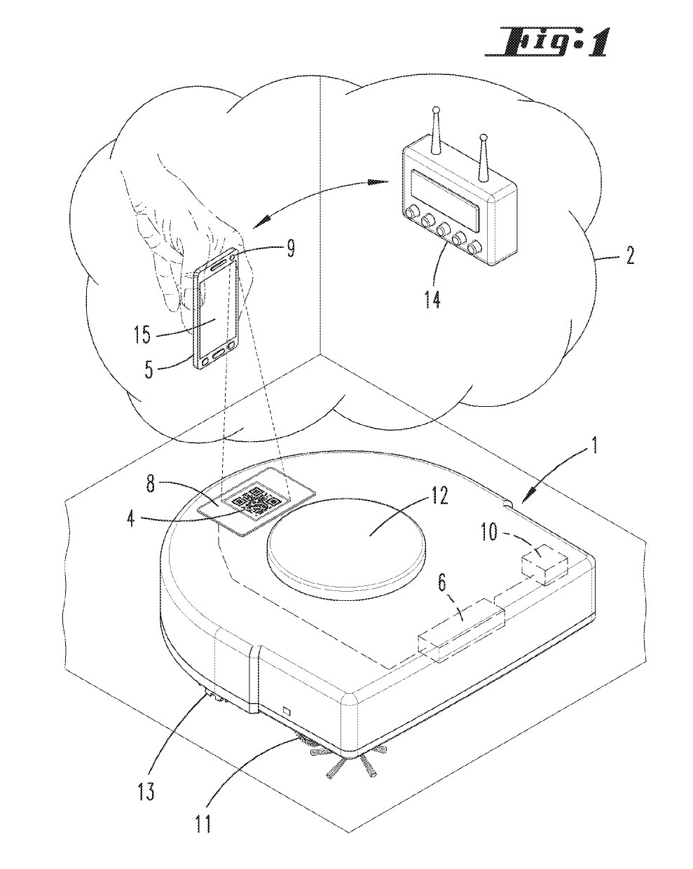

FIG. 1 shows a home network 2, in this example a conventional Wi-Fi network, with an access point 14 and a user terminal 5. FIG. 1 furthermore shows a household appliance 1 that, however, is not yet logged on to the home network 2. The household appliance 1, the user terminal 5 and the access point 14 feature Wi-Fi radio modules for the communication. In this case, the household appliance 1 is a self-traveling cleaning apparatus, namely a vacuuming robot. The user terminal 5 is a smartphone.

The household appliance 1 features a not-shown navigation and self-localization device, by means of which the household appliance 1 can orient itself and travel within an environment. The navigation and self-localization device evaluates measuring data of a distance measuring device 12, which in this case consists, for example, of an all-around laser scanner in the form of a laser triangulation system. The distance measuring device 12 measures distances from obstacles and room boundaries. This measuring data is preferably compared with measuring data of an odometry sensor that measures the distance traveled by the household appliance 1. The information on obstacles and room boundaries of the environment is processed into an environment map of the household appliance 1, by means of which the household appliance 1 can orient itself in the environment. The household appliance 1 also features a cleaning element 11 for treating a surface to be cleaned. In this case, the cleaning element 11 consists, for example, of a bristle roller that is driven by an electric motor. The household appliance 1 furthermore features multiple motor-driven wheels 13 that serve for the progressive motion of the household appliance 1 within the environment. In addition, a screen 8 for displaying various information is arranged on an upper side of the household appliance 1.

The user terminal 5 features a screen 15 and an image sensor 9, namely a camera. The screen 15 is preferably a touchscreen that serves for displaying various information and keys. The keys can be actuated by pressing thereon. An application for communicating and cooperating with the household appliance 1 is installed on the user terminal 5.

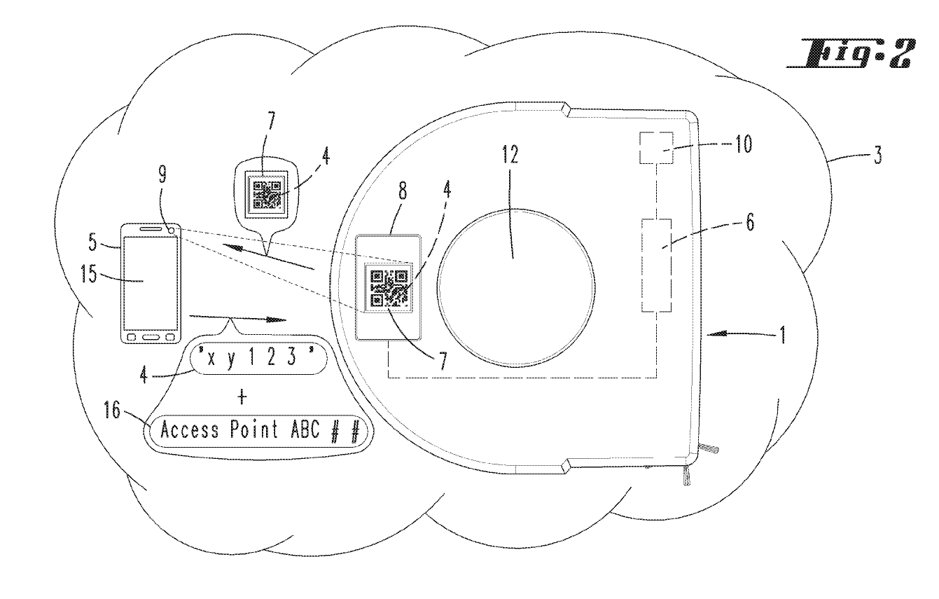

The situation illustrated in FIG. 1 shows a time, at which the household appliance 1 is not yet logged on to the home network 2. In order to log on to the home network 2, the household appliance 1 requires network access information 16 for the access point 14. In order to obtain this network access information, the household appliance 1 establishes a temporary network 3, to which the user terminal 5 can connect. This situation is illustrated in FIG. 2.

FIG. 2 shows the temporary network 3 of the household appliance 1 with a user terminal 5. The hotspot device 10 of the household appliance 1, for example a network module with access point function, establishes the temporary network 3 with a hotspot identification 4, which is generated by means of a random character generator 6. This hotspot identification 4 serves as SSID of the temporary network 3. The random character generator 6 generates the hotspot identification 4 of randomly selected characters, which in this example form a random sequence of letters and numbers, namely the hotspot identification 4 “XY123.” A computing unit of the household appliance 1 subsequently transforms the hotspot identification 4 into an optical code 7, in this case a QR code, which contains the hotspot identification 4 in encoded form. The optical code 7 is displayed on the screen 8 of the household appliance 1. In order to connect the user terminal 5 to the temporary network 3, it is moved into the vicinity of the household appliance 1 in such a way that the image sensor 9 of the user terminal 5 points at the screen 8 of the household appliance 1 and the optical code 7 lies within the scanning range of the image sensor 9. The application installed on the user terminal 5 is opened and controls the image sensor 9. Subsequently, the image sensor 9 detects the optical code 7 and forwards this optical code to a computing unit of the user terminal 5, which extracts the hotspot identification 4 from the optical code 7. The user terminal 5 can now log on to the temporary network 3 of the household appliance 1 by means of this hotspot identification 4. The user terminal 5 then transmits network access information 16 to the household appliance 1 via the temporary network 3. The transmission of the hotspot identification 4 and the network access information 16 takes place by means of the Wi-Fi radio modules of the user terminal 5 and the household appliance 1. In this example, the network access information 16 is the character sequence “Access Point ABC##.” This network access information serves for logging on the household appliance 1 to the home network 2.

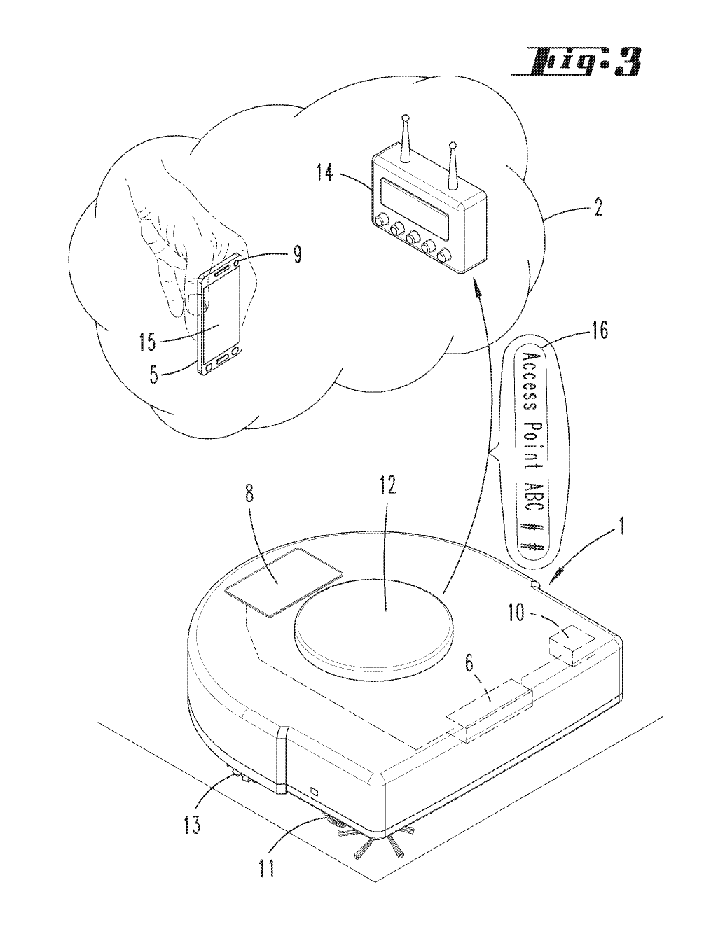

The hotspot device 10 closes the temporary network 3 after the transmission via the temporary network 3 of the household appliance 1 illustrated in FIG. 2 has been completed. Subsequently, the household appliance 1 logs on to the home network 2 as shown in FIG. 3. For this purpose, the household appliance 1 particularly transmits the previously received network access information 16 “Access Point ABC##” to the access point 14 of the home network 2. The access point 14 checks if the network access information 16 is correct and allows the household appliance 1 to log on to the home network 2 if the network access information matches.

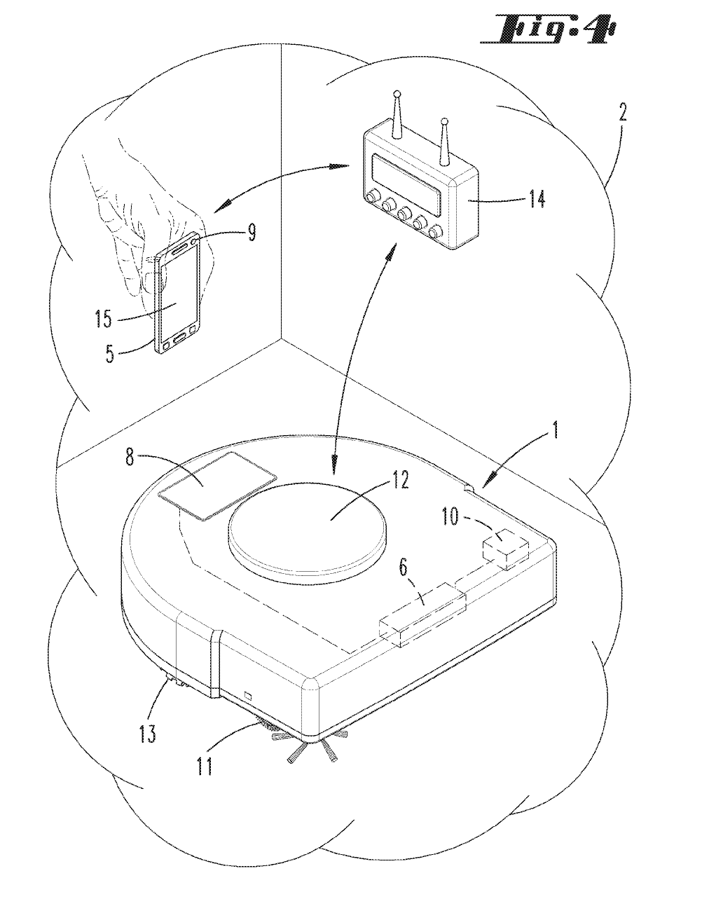

FIG. 4 shows the home network 2 after the household appliance 1 has logged on thereto. The access point 14 and the user terminal 5, as well as the access point 14 and the household appliance 1, communicate with one another in this home network 2.

### LIST OF REFERENCE SYMBOLS

1 Household appliance

2 Home network

3 Temporary network

4 Hotspot identification

5 User terminal

6 Random character generator

7 Optical code

8 Screen

9 Image sensor

10 Hotspot device

11 Cleaning element

12 Distance measuring device

13 Wheel

14 Access point

15 Screen

16 Network access information

1: A method for connecting a household appliance (1) to a wireless home network (2), wherein the household appliance (1) makes available a temporary network (3) with a hotspot identification (4), wherein a user terminal (5) is connected to the household appliance (1) via the temporary network (3) by utilizing the hotspot identification (4), wherein the user terminal (5) transmits network access information (16) to the household appliance (1), and wherein the household appliance (1) closes the temporary network (3) after the reception of the network access information (16) and logs on to the home network (2) by utilizing the received network access information (16), wherein the hotspot identification (4) of the temporary network (3) is randomly generated by means of a random character generator (6) and output in the form of an optical code (7).

2: The method according to claim 1, wherein the random character generator (6) generates the hotspot identification (4) immediately before the temporary network (3) is established or at the moment the temporary network (3) is established.

3: The method according to claim 1. wherein the hotspot identification (4) is generated in the form of a sequence of randomly selected numerals and/or letters and/or special characters.

4: The method according to claim 1,
wherein hotspot identification (4) is displayed on a screen (8) of the household appliance (1) in the form of a two-dimensional code, particularly a QR® code (Quick Response code).

5: The method according to claim 4, wherein the optical code (7) is received by means of an image sensor (9) of the user terminal (5).

6: The method according to claim 4, wherein the optical code (7) is processed by means of an application installed on the user terminal (5) and the hotspot identification (4) is extracted from the optical code (7).

7: The method according to claim 1, wherein the hotspot identification (4) becomes invalid no later than at the time, at which the temporary network (3) is closed.

8: A household appliance (1) with a hotspot device (10) for making available a temporary network (3) and with a device for making available a hotspot identification (4) for accessing the temporary network (3), wherein the device for making available the hotspot identification (4) features a random character generator (6), which is designed for generating the hotspot identification (4) of randomly selected numerals and/or letters and/or special characters, wherein the household appliance (1) features a screen (8) for displaying a two-dimensional optical code containing the hotspot identification (4).

9: The household appliance (1) according to claim 8, wherein the two-dimensional optical code (7) is a QR® code (Quick Response code).
